(19) United States
(12) Patent Application Publication
(10) Pub. No.: US 2026/0109629 A1
(43) Pub. Date: Apr. 23, 2026

(54) DYNAMIC DOSING SYSTEM AND METHOD FOR BIOLOGICAL WASTEWATER TREATMENT

(71) Applicant: Claire Cunningham, Mission Hills, KS (US)

(72) Inventors: Claire Cunningham, Mission Hills, KS (US); Jason Cunningham, Mission Hills, KS (US)

(21) Appl. No.: 18/920,499

(22) Filed: Oct. 18, 2024

(51) Int. Cl. C02F 3/00; C02F 3/02; C02F 103/44

(52) U.S. Cl. CPC C02F 3/006; C02F 3/02; C02F 2103/44; C02F 2209/006; C02F 2209/36; C02F 2303/02

(57) ABSTRACT

A method is provided for treating wastewater by dosing biological agents comprising dynamically adjusting dosing patterns of biological agents based on methodologies comprising at least one of chronotherapy, pulsed dosing, stepwise dosing, bolus dosing, continuous dosing, manual dosing, and automatic dosing. The method also comprises introducing biological agents into the wastewater to facilitate cleaning and malodor elimination. The biological agents comprise aerobic bacteria that promote odor reduction by competing with anaerobic bacteria responsible for generating malodors. The method also comprises adjusting the concentration and type of biological agents introduced into the wastewater based on time-of-day and circadian rhythm-based variations in microbial activity within the wastewater system. Real-time monitoring is performed at multiple locations within a wastewater treatment facility to dynamically adjust dosing patterns for each location independently.

### CROSS-REFERENCE TO RELATED APPLICATIONS

None.

### FIELD OF THE DISCLOSURE

The present disclosure is in the field of wastewater treatment systems. More particularly, the present disclosure describes systems and methods providing dynamic dosing of biological agents to promote healthy microbial colonization in wastewater with applications in various industries including vehicle wash facilities, with systems and methods further directed to improvement of water quality, elimination of malodor, and promotion of environmental sustainability by optimizing dosing patterns based on real-time water quality data.

### BACKGROUND

Wastewater generated by industries such as vehicle wash facilities is often heavily contaminated with oils, chemicals, and organic matter. Current methods to manage this wastewater typically involve filtration and chemical treatments, which can be expensive, inefficient, and unable to maintain water quality for reuse. Additionally, these conventional systems often fail to prevent malodors caused by anaerobic bacterial growth, necessitating frequent maintenance and increasing operational costs.

Biological treatments, in which microbes are introduced to break down organic contaminants, provide a sustainable alternative. However, static dosing schedules for biological agents often fall short of the dynamic needs of wastewater environments. Water quality parameters such as pH, oxygen levels, and organic load vary throughout the day, and traditional methods cannot adequately adjust to these fluctuations. A need exists for a system that can dynamically dose biological agents to match changing conditions and enhance the efficiency of the treatment process.

### SUMMARY

The present disclosure provides systems and methods for dynamically dosing biological agents into wastewater. Systems are designed to monitor water quality conditions in real time and adjust the dosing patterns of biological agents to promote optimal colonization of beneficial microbes, which break down contaminants and suppress malodors.

Systems provided herein incorporate various dosing methodologies that adapt to changing conditions of wastewater. These methodologies include:
1. Chronotherapy—Dosing biological agents in sync with natural circadian or environmental cycles.
2. Pulsed Dosing—Administering doses at intervals, allowing rest periods between doses.
3. Stepwise Dosing—Gradually increasing the dosage over time to build up microbial colonies.
4. Bolus Dosing—Administering larger, less frequent doses to promote rapid microbial establishment.
5. Continuous Dosing—Maintaining a steady supply of biological agents.

Additionally, systems support a multi-site mode, a dashboard view where a customer with the necessary subscription level can see all the information for sites in their enterprise. The multi-site mode may allow a user to manage multiple wastewater treatment locations simultaneously. Systems allow for on-the-fly adjustment of dosing schedules based upon projections for biome development at each location and schedules can be adjusted dynamically to optimize treatment efficacy.

By tailoring dosing schedules to the specific needs of each wastewater treatment site, systems promote healthy colonization of biological agents, enhance contaminant breakdown, and reduce malodors. Systems and methods provided herein may be ideal for applications such as vehicle wash facilities, where wastewater quality fluctuates and there is a need for sustainable, cost-effective water treatment solutions.

### BRIEF DESCRIPTION OF THE FIGURES

FIG. 1 illustrates a process flow diagram depicting dynamic dosing of biological agents into a wastewater system and the subsequent impact on water purity and ability for reuse.

FIG. 2 shows a schematic of the dosing system main control unit.

FIG. 3 depicts a graphic of an inventory system built into the dosing system that provides a depiction of the inventory level in the holding tank.

### DETAILED DESCRIPTION

Overview: The present disclosure provides dynamic dosing systems for treating wastewater, particularly in industries that produce high volumes of wastewater, such as vehicle wash facilities. Systems use real-time monitoring to adjust the dosing of biological agents, which are introduced to promote healthy microbial growth that breaks down organic contaminants and reduces malodor. Systems are designed to be adaptable, with multiple dosing methodologies employed based on the specific needs of each site.

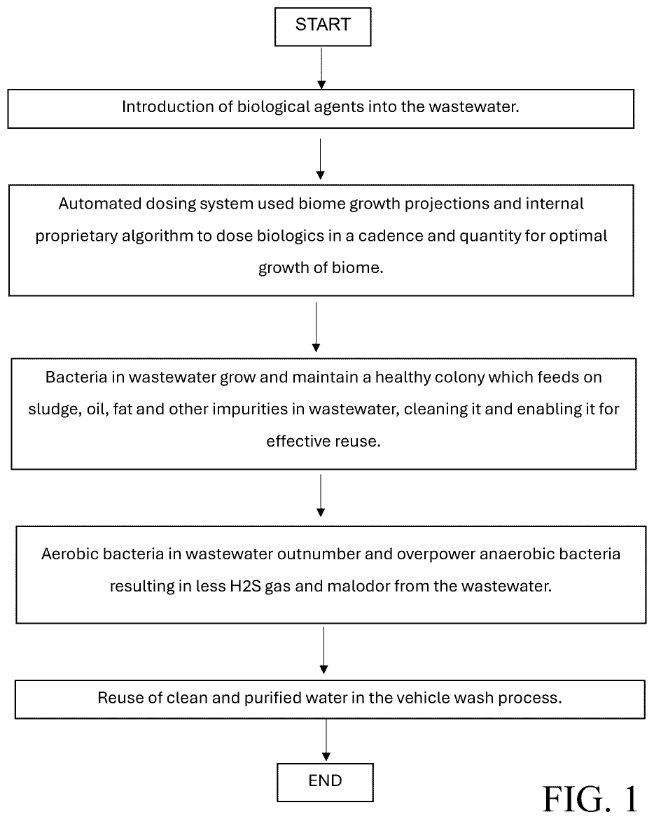

Process Flow (FIG. 1): In the process illustrated in FIG. 1, wastewater from a treatment site is dosed with biological agents to generate a healthy biome of aerobic bacteria. The automated dosing system uses biome growth projections and an internal proprietary algorithm to determine an optimal cadence and volume for dosing of biological agents. The control unit dynamically adjusts the dose and timing based on these parameters.

For example, during the inoculation period where the system is working to establish a biological colony in a new body of water, the system may switch to Bolus Dosing to quickly introduce a large amount of biological agents. Conversely, during periods of stability, Chronotherapy or Continuous Dosing may be used to maintain healthy microbial colonies.

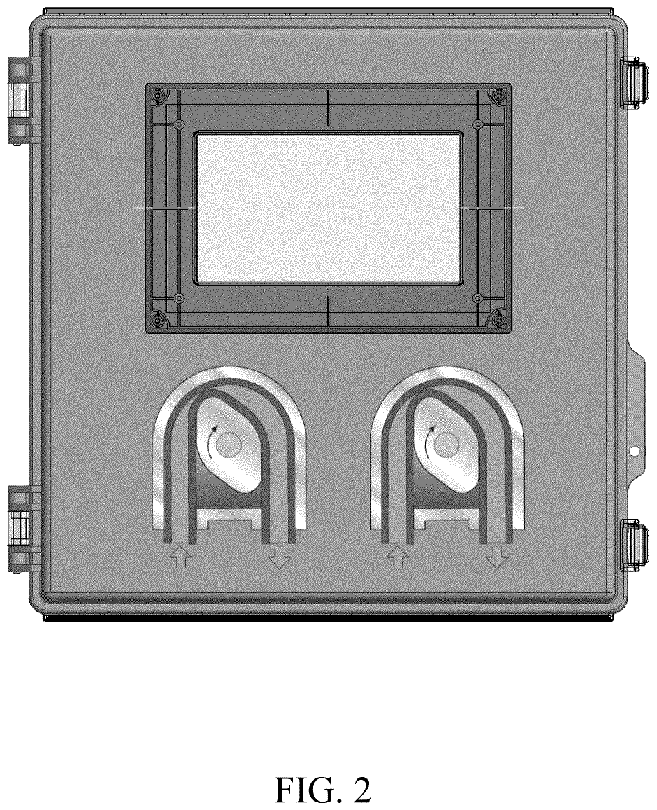

System Components (FIG. 2): As shown in FIG. 2, an exemplary system comprises:
Control unit: The control unit contains timing mechanisms and control wiring to enable system functionality.
Dosing mechanism: This component administers the biological agents into the wastewater in accordance with the dosing schedule set by the control unit.
Multi-Site Access and Control: Systems are web-enabled and accessible from anywhere for remote management and control.

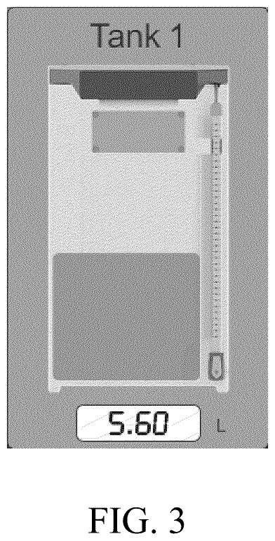

Inventory Tank (FIG. 3): FIG. 3 illustrates the inventory tank used to store the biological agents before they are introduced into the wastewater. The tank is equipped with level sensors to measure the volume remaining in the tank. Setpoints for low tank levels can trigger email and text alerts as well as automatic orders to replenish biological agents since it is crucial to the health of the biome to continue dosing on the required interval.

Multi-Site Mode: The system is capable of operating in multi-site mode, where it can monitor and control dosing at multiple wastewater treatment locations simultaneously. Each site has its own set of sensors and dosing mechanisms, but all sites are controlled centrally. This allows for real-time adjustments at each site based on specific water quality conditions.

Benefits: The dynamic dosing system provided herein offers several advantages over conventional static dosing methods:
Optimized microbial colonization: By adjusting dosing patterns in real time, the system ensures that beneficial microbes can thrive and effectively break down organic contaminants.
Malodor reduction: Systems promote aerobic bacterial growth, which suppresses anaerobic, odor-causing bacteria.
Cost savings: By using biological agents efficiently and reducing the need for chemical treatments, systems promote reduced operational costs.
Sustainability: Systems reduce environmental impact of wastewater treatment by promoting biological methods over chemical treatments.

In an embodiment, a method is provided for treating wastewater by dosing biological agents comprising dynamically adjusting dosing patterns of biological agents based on methodologies comprising at least one of chronotherapy, pulsed dosing, stepwise dosing, bolus dosing, continuous dosing, manual dosing, and automatic dosing. The method also comprises introducing biological agents into the wastewater to facilitate cleaning and malodor elimination.

The biological agents comprise aerobic bacteria that promote odor reduction by competing with anaerobic bacteria responsible for generating malodors. The method also comprises adjusting the concentration and type of biological agents introduced into the wastewater based on time-of-day and circadian rhythm-based variations in microbial activity within the wastewater system. Real-time monitoring is performed at multiple locations within a wastewater treatment facility to dynamically adjust dosing patterns for each location independently.

In another embodiment, a system for treating wastewater is provided comprising a dosing system configured to release biological agents into wastewater at intervals determined by dynamic dosing patterns comprising one or more of chronotherapy, pulsed dosing, stepwise dosing, bolus dosing, continuous dosing, manual dosing, and automatic dosing. The system also comprises a control unit programmed to adjust dosing patterns based on projections for biome development over a period of time and at least one sensor monitoring availability of the biological agents for dosing to promote uninterrupted availability of the agents.

The system also comprises a multi-site mode for monitoring multiple wastewater treatment locations, wherein each site has independent sensors to measure availability of biological agents to promote uninterrupted availability thereof. Each site also has a dosing control system that adjusts dosing patterns at each site independently based on the projected needs of the water being treated based upon projection of biome development. The system also comprises a centralized monitoring station capable of receiving and analyzing real-time data from multiple locations, and remotely adjusting the dosing patterns at each site. Each location can establish specific email and text message alerts and parameters for alerts that will allow each to function independently while also being monitored remotely by a home office, multi-location management entity. The dosing system is configured to automatically shift between dynamic dosing patterns depending on projections for biome development in the water and other observations and manual tests performed on the body of water in question. The system also comprises an ability to preemptively dose biological agents before predicted high loads of contaminants in the wastewater, adjusting the dosing schedules to prevent spikes in malodor or contaminant levels.

Conclusion: Systems and methods described herein provide an advanced solution for dynamic dosing of biological agents in wastewater treatment. The systems'ability to adjust dosing patterns based on real-time data promotes healthier water ecosystems, reduces operational costs, and supports environmental sustainability.

1. A method for treating wastewater by dosing biological agents comprising:
dynamically adjusting dosing patterns of biological agents based on at least one of the following methodologies:
1. Chronotherapy,
2. Pulsed Dosing,
3. Stepwise Dosing,
4. Bolus Dosing,
5. Continuous Dosing;
6. Manual Dosing
7. Automatic Dosing, and
introducing biological agents into the wastewater to facilitate cleaning and malodor elimination.

2. The method of claim 1, wherein the biological agents comprise aerobic bacteria that promote odor reduction by competing with anaerobic bacteria responsible for generating malodor.

3. The method of claim 1, further comprising adjusting the concentration and type of biological agents introduced into the wastewater based on time-of-day and circadian rhythm-based variations in microbial activity within the wastewater system.

4. The method of claim 1, wherein real-time monitoring is performed at multiple locations within the wastewater treatment facility to dynamically adjust the dosing patterns for each location independently.

5. A system for treating wastewater comprising:
a dosing system configured to release biological agents into wastewater at intervals determined by dynamic dosing patterns comprising one or more of chronotherapy, pulsed dosing, stepwise dosing, bolus dosing, continuous dosing, manual dosing, and automatic dosing;
a control unit programmed to adjust dosing patterns based on projections for biome development over a period of time; and
at least one sensor monitoring availability of the biological agents for dosing to promote uninterrupted availability of the agents.

6. The system of claim 5, further comprising a multi-site mode for monitoring multiple wastewater treatment locations, wherein each site has:
independent sensors to measure availability of biological agents to promote uninterrupted availability thereof; and
a dosing control system that adjusts dosing patterns at each site independently based on the projected needs of the water being treated based upon projection of biome development.

7. The system of claim 5, further comprising a centralized monitoring station capable of receiving and analyzing real-time data from multiple locations, and remotely adjusting the dosing patterns at each site.

8. The system of claim 5, wherein each location can establish specific email and text message alerts and parameters for alerts that will allow each to function independently while also being monitored remotely by a home office, multi-location management entity.

9. The system of claim 5, wherein the dosing system is configured to automatically shift between dynamic dosing patterns depending on projections for biome development in the water and other observations and manual tests performed on the body of water in question.

10. The system of claim 5, further comprising an ability to preemptively dose biological agents before predicted high loads of contaminants in the wastewater, adjusting the dosing schedules to prevent spikes in malodor or contaminant levels.
